(19) United States
(12) Patent Application Publication
(10) Pub. No.: US 2025/0271696 A1
(43) Pub. Date: Aug. 28, 2025

(54) COLOR FILTER SUBSTRATE AND DISPLAY DEVICE

(71) Applicant: HANNSTAR DISPLAY CORPORATION, Taipei City (TW)

(72) Inventors: Wei-Chi Wu, Taipei City (TW); Yao-Chih Chuang, Taipei City (TW); Chih-Wei Chen, Taipei City (TW); Wai-Chen Lin, Taipei City (TW); Yung-Tsung Chen, Taipei City (TW); Kuo-Feng Chen, Taipei City (TW)

(73) Assignee: HANNSTAR DISPLAY CORPORATION, Taipei City (TW)

(21) Appl. No.: 19/002,649

(22) Filed: Dec. 26, 2024

Related U.S. Application Data
(60) Provisional application No. 63/556,404, filed on Feb. 22, 2024.

(30) Foreign Application Priority Data
Apr. 19, 2024 (TW) 113114612
Apr. 22, 2024 (TW) 113114848

(51) Int. Cl. G02F 1/1335

(52) U.S. Cl. CPC G02F 1/133514

(57) ABSTRACT

A color filter substrate including a substrate and a color resist structure is disclosed. The substrate has a pixel region, and the pixel region includes a first sub-pixel region, a second sub-pixel region and a third sub-pixel region. The color resist structure is disposed on the substrate, and the color resist structure includes a first color resist, a second color resist and a third color resist. The first color resist is disposed in the first sub-pixel region. The second color resist is disposed in the second sub-pixel region. A portion of the third color resist is disposed in at least one of the first sub-pixel region and the second sub-pixel region, and another portion of the third color resist is disposed in the third sub-pixel region. The first color resist, the second color resist and the third color resist have different colors from each other.

### CROSS REFERENCE TO RELATED APPLICATIONS

This application claims the benefit of U.S. Provisional Application No. 63/556,404, filed on Feb. 22, 2024. The content of the application is incorporated herein by reference.

### BACKGROUND OF THE INVENTION

### 1. Field of the Invention

The present invention relates to a color filter substrate, and more particularly to a color filter substrate including a plurality of color resists and a display device to which it is applied.

### 2. Description of the Prior Art

Color filter substrates have been widely used in various display devices, such as notebooks, smart phones, wearable devices, smart watches and display screens for vehicles. During the manufacturing process of a display device, there are many processes that may cause the originally set target white point of the device to shift. For example, in the display device, the color of light emitted by a light source may change when passing through some layers because of the material of theses layers, which makes the preset white point of the display image shift (such as yellow shift), thus affecting the display quality of the display device.

### SUMMARY OF THE INVENTION

One of the objectives of the present invention is to provide a color filter substrate and a display device to which it is applied, wherein through the arrangement and structural design of different color resists of the color filter substrate, the problem of yellow shift of the white point may be mitigated.

In order to achieve the above objectives, the present invention provides a color filter substrate including a substrate and a color resist structure. The substrate has a pixel region, and the pixel region includes a first sub-pixel region, a second sub-pixel region and a third sub-pixel region. The color resist structure is disposed on the substrate, and the color resist structure includes a first color resist, a second color resist and a third color resist. The first color resist is disposed in the first sub-pixel region. The second color resist is disposed in the second sub-pixel region. A portion of the third color resist is disposed in at least one of the first sub-pixel region and the second sub-pixel region, and another portion of the third color resist is disposed in the third sub-pixel region. The first color resist, the second color resist and the third color resist have different colors from each other

In order to achieve the above objectives, the present invention provides a display device including the above-mentioned color filter substrate and an array substrate, and the array substrate and the color filter substrate are disposed opposite to each other.

According to the color filter substrates and the display devices of the embodiments of the present invention, through the arrangement and structural design of different color resists of the color filter substrate that the third color resist is not only disposed in the third sub-pixel region but also in at least one of the first sub-pixel region and the second sub-pixel region, the problem of yellow shift of the white point may be mitigated or solved, thereby improving the display quality of the product.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram illustrating a top view of a color filter substrate according to a first embodiment of the present invention.

FIG. 2 is a schematic diagram illustrating a partial cross-sectional view of a color filter substrate according to a first embodiment of the present invention.

FIG. 3 is a schematic diagram illustrating a top view of a color filter substrate according to a second embodiment of the present invention.

FIG. 4 is a schematic diagram illustrating a partial cross-sectional view of a color filter substrate according to a second embodiment of the present invention.

FIG. 5 is a schematic diagram illustrating another partial cross-sectional view of a color filter substrate according to a second embodiment of the present invention.

FIG. 6 is a schematic diagram illustrating a top view of a color filter substrate according to a third embodiment of the present invention.

FIG. 7 is a schematic diagram illustrating a partial cross-sectional view of a color filter substrate according to a third embodiment of the present invention.

FIG. 8 is a schematic diagram illustrating a top view of a color filter substrate according to a fourth embodiment of the present invention.

FIG. 9 is a schematic diagram illustrating a partial cross-sectional view of a color filter substrate according to a fourth embodiment of the present invention.

FIG. 10A is a schematic diagram illustrating a partial cross-sectional view of a display device according to an embodiment of the present invention.

FIG. 10B is a schematic diagram illustrating a partial cross-sectional view of a display device according to another embodiment of the present invention.

FIG. 10C is a schematic diagram illustrating a partial cross-sectional view of a display device according to still another embodiment of the present invention.

FIG. 11 is a graph diagram illustrating the relationship between different thicknesses of a transparent conductive layer and color coordinate values according to an embodiment of the present invention.

FIG. 12 and FIG. 13 are schematic diagrams illustrating partial processes of a manufacturing method of a color filter substrate according to a first embodiment of the present invention.

FIG. 14 to FIG. 16 are schematic diagrams illustrating partial processes of a manufacturing method of a color filter substrate according to a second embodiment of the present invention.

### DETAILED DESCRIPTION

For understanding the present invention, the features and desired effects of the present invention are described in detail with reference to the following embodiments, taken in conjunction with the drawings. It should be noted that the drawings are simplified schematic diagrams, so that only the components and their relationships related to the present invention are shown in order to provide a clear description of the basic architecture or implementation of the present invention. It will be understood by one skilled in the art that the practical components and layout may be more detailed. In addition, for the convenience of illustration, the components shown in various drawings of the present invention are not drawn in proportion with respect to their actual number, shape and size in practice, and the detailed proportions thereof may be adjusted according to the design requirements.

In the following description and in the claims, the terms “include”, “comprise” and “have” are used in an open-ended fashion, and thus should be interpreted to mean “include, but not limited to . . . ”. When the terms “include”, “comprise” and/or “have” are used in the description of the present invention, the corresponding features, areas, steps, operations and/or components are not limited to the specific embodiment, and the addition of one or a plurality of the corresponding or other features, areas, steps, operations, components and/or combinations thereof are also included in the scope of the application.

The ordinal numbers used in the description and claims, such as “first”, “second”, “third”, etc., are used to describe elements, but they do not mean or represent that the element(s) have any previous ordinal numbers, nor do they represent the order of one element and another element, or the order of manufacturing methods. The ordinal numbers are used only to clearly distinguish an element with a certain name from another element with the same name. The claims and the description may not use the same terms. Accordingly, a first constituent element in the following description may be a second constituent element in a claim.

According to the embodiments of the present invention, the thickness of each element may be measured by an optical microscope (OM), a scanning electron microscope (SEM) or other suitable means. For example, the scanning electron microscope may be used to obtain an image of the cross-sectional structure including to-be-measured elements, and the thickness of each element is measured accordingly, but not limited herein.

It should be noted that the technical features in different embodiments described in the following can be replaced, recombined, or mixed with one another to constitute another embodiment without departing from the spirit of the present invention.

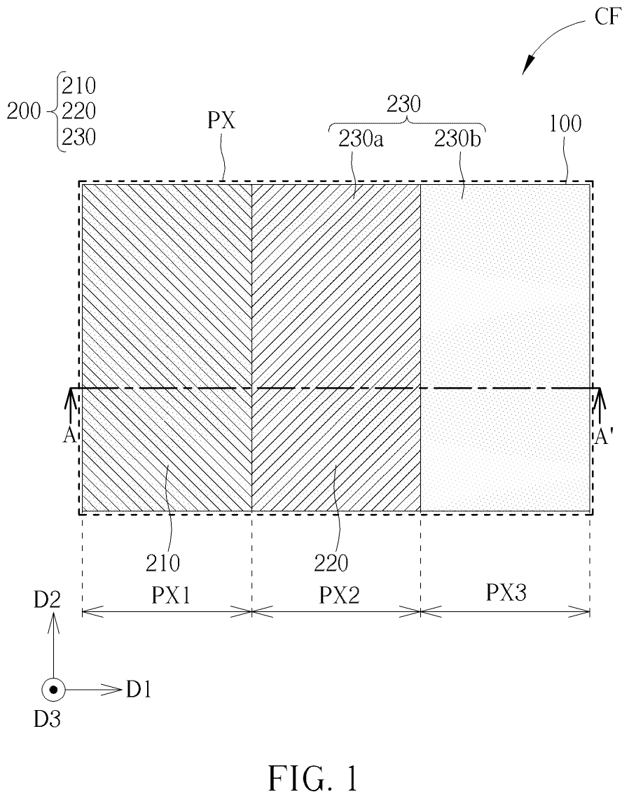

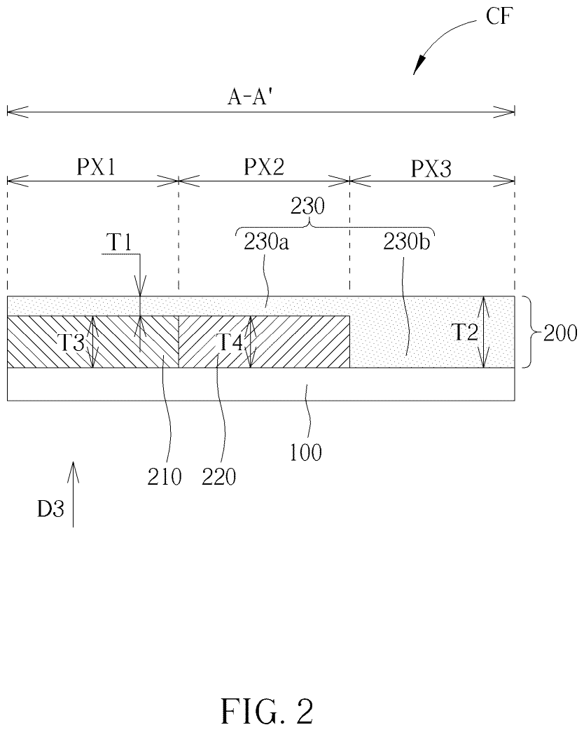

Refer to FIG. 1 and FIG. 2. FIG. 1 is a schematic diagram illustrating a top view of a color filter substrate according to a first embodiment of the present invention. FIG. 2 is a schematic diagram illustrating a partial cross-sectional view of a color filter substrate according to a first embodiment of the present invention, wherein FIG. 2 is a cross-sectional view along a section line A-A′ in FIG. 1. As shown in FIG. 1 and FIG. 2, a color filter substrate CF includes a substrate 100 and a color resist structure 200. The substrate 100 has a pixel region PX, and the pixel region PX includes a first sub-pixel region PX1, a second sub-pixel region PX2 and a third sub-pixel region PX3. In some embodiments, the first sub-pixel region PX1, the second sub-pixel region PX2 and the third sub-pixel region PX3 may be arranged side by side in a first direction D1. Each of the first sub-pixel region PX1, the second sub-pixel region PX2 and the third sub-pixel region PX3, for example, has a rectangular shape with two sides parallel to the first direction D1 and the other two sides parallel to a second direction D2. The first direction D1 and the second direction D2 may be perpendicular to each other and perpendicular to a third direction D3 at the same time, wherein the third direction D3 is a normal direction of the substrate 100 in the present invention, i.e., the third direction D3 may be parallel to the normal direction of an upper surface or a lower surface of the substrate 100. The shapes and arrangement of the first sub-pixel region PX1, the second sub-pixel region PX2 and the third sub-pixel region PX3 are not limited to the above and may be other suitable shapes and/or arrangements or be designed according to product requirements. For example, a left side and/or a right side of at least one of the first sub-pixel region PX1, the second sub-pixel region PX2 and the third sub-pixel region PX3 may be an oblique line, which has an included angle greater than 0 degrees and less than 90 degrees with the second direction D2; or a left side and/or a right side of at least one of the first sub-pixel region PX1, the second sub-pixel region PX2 and the third sub-pixel region PX3 may have two oblique lines that are coupled with each other and extend along directions not parallel to each other, wherein the above two oblique lines have an included angle greater than 0 degrees and less than 90 degrees with the second direction D2 respectively. In addition, in some embodiments, the arrangement of the first sub-pixel region PX1, the second sub-pixel region PX2 and the third sub-pixel region PX3 in one pixel region PX may not be a straight line arrangement. It should be noted that FIG. 1 only depicts a schematic diagram of a top view of one pixel region PX of the color filter substrate CF. The color filter substrate CF may have a plurality of pixel regions PX arranged along the first direction D1 and the second direction D2, and the schematic diagrams of a top view and a cross-sectional view of each pixel region PX may refer to FIG. 1 and FIG. 2 respectively, which will not be described redundantly herein. The substrate 100 may include a rigid substrate or a flexible substrate. The material of the rigid substrate may include glass, ceramics, quartz, or sapphire, but not limited herein. The material of the flexible substrate may include polyimide (PI), polycarbonate (PC), polyethylene terephthalate (PET), or poly(methyl methacrylate) (PMMA), but not limited herein.

The color resist structure 200 is disposed on the substrate 100, and the color resist structure 200 includes a first color resist 210, a second color resist 220 and a third color resist 230. The first color resist 210 is disposed in the first sub-pixel region PX1, and the second color resist 220 is disposed in the second sub-pixel region PX2. The third color resist 230 is disposed in the first sub-pixel region PX1, the second sub-pixel region PX2 and the third sub-pixel region PX3 at the same time, and the third color resist 230 covers the first color resist 210 and the second color resist 220 in the third direction D3. That is to say, in the third direction D3, a portion of the third color resist 230 may be overlapped with the first color resist 210, and another portion of the third color resist 230 may be overlapped with the second color resist 220.

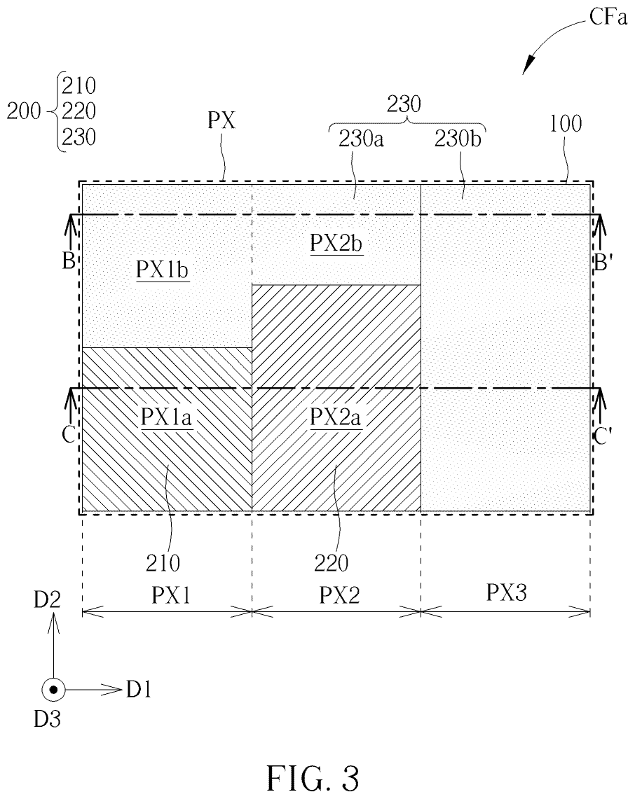

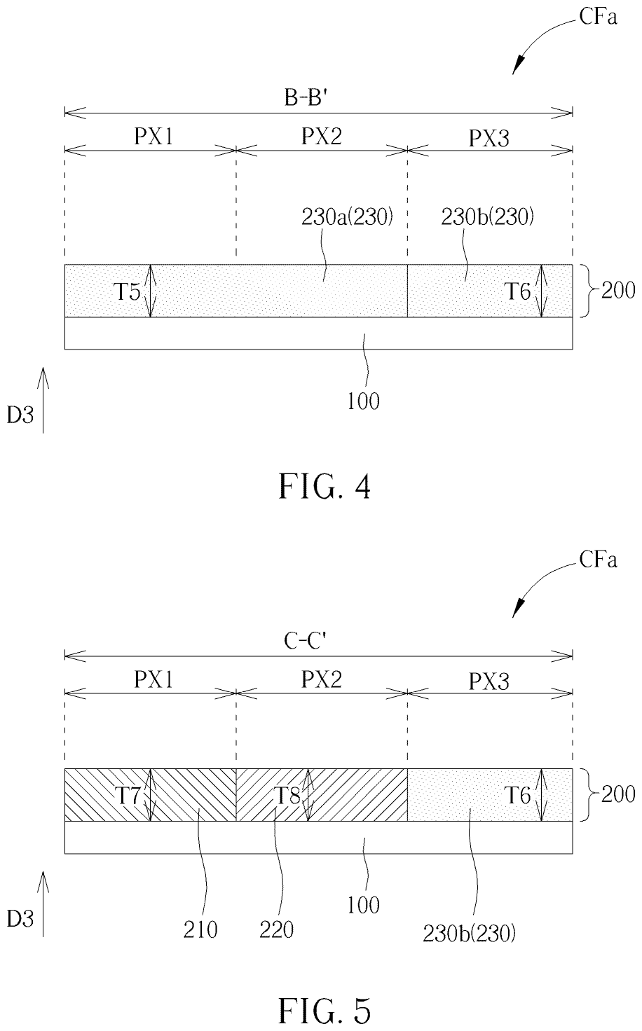

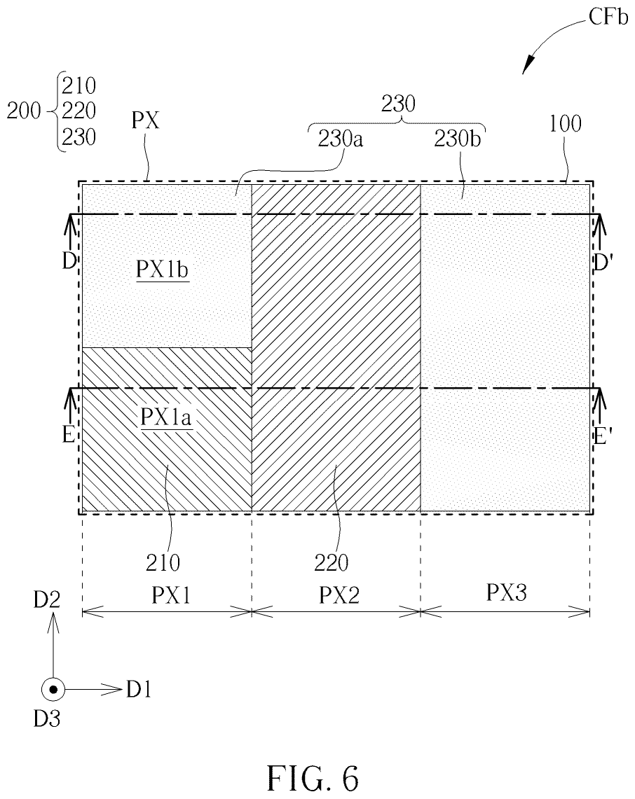

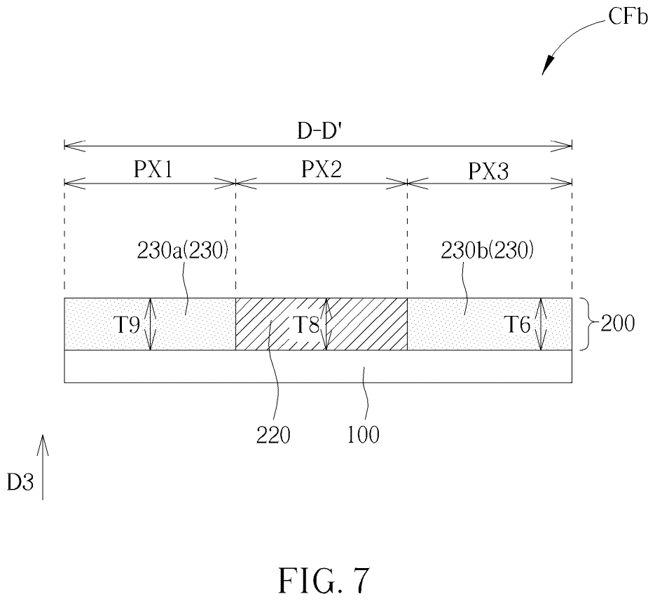

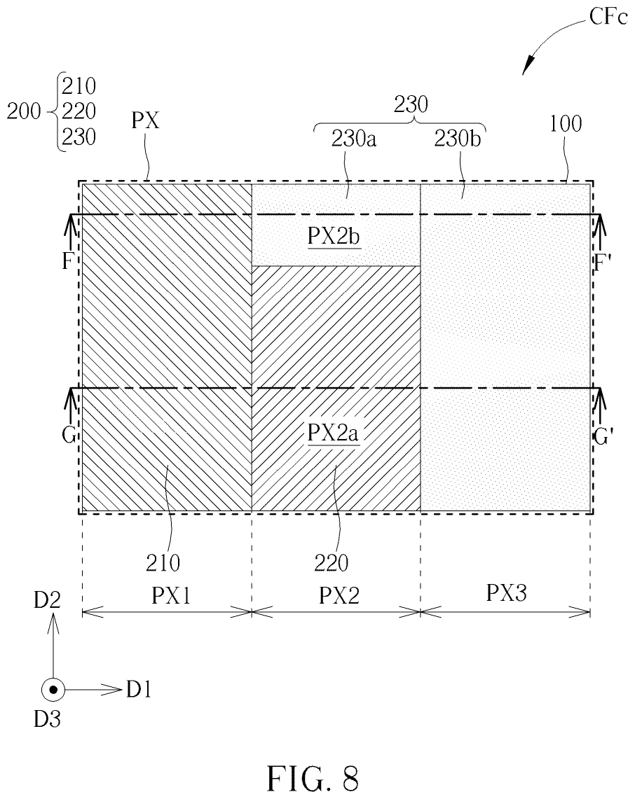

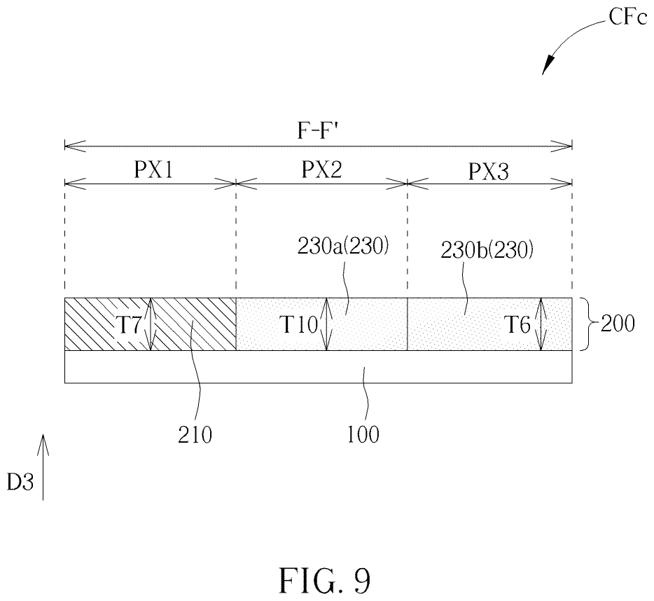

FIG. 3 is a schematic diagram illustrating a top view of a color filter substrate according to a second embodiment of the present invention. FIG. 4 is a schematic diagram illustrating a partial cross-sectional view of a color filter substrate according to a second embodiment of the present invention. FIG. 5 is a schematic diagram illustrating another partial cross-sectional view of a color filter substrate according to a second embodiment of the present invention. FIG. 6 is a schematic diagram illustrating a top view of a color filter substrate according to a third embodiment of the present invention. FIG. 7 is a schematic diagram illustrating a partial cross-sectional view of a color filter substrate according to a third embodiment of the present invention. FIG. 8 is a schematic diagram illustrating a top view of a color filter substrate according to a fourth embodiment of the present invention. FIG. 9 is a schematic diagram illustrating a partial cross-sectional view of a color filter substrate according to a fourth embodiment of the present invention. Wherein, FIG. 4 is a cross-sectional view along a section line B-B′in FIG. 3, FIG. 5 is a cross-sectional view along a section line C-C′ in FIG. 3, FIG. 7 is a cross-sectional view along a section line D-D′in FIG. 6, and FIG. 9 is a cross-sectional view along a section line F-F′ in FIG. 8. It should be noted that the cross-sectional views of a section line E-E′ in FIG. 6 and a section line G-G′ in FIG. 8 are the same as the cross-sectional view of FIG. 5, and thus they are omitted from illustration.

As shown in FIG. 3, FIG. 4 and FIG. 5, a color filter substrate CFa includes a substrate 100 and a color resist structure 200. The color resist structure 200 is disposed on the substrate 100, and the color resist structure 200 includes a first color resist 210, a second color resist 220 and a third color resist 230. The first color resist 210 is disposed in the first sub-pixel region PX1, and the second color resist 220 is disposed in the second sub-pixel region PX2. A portion 230a of the third color resist 230 is disposed in at least one of the first sub-pixel region PX1 and the second sub-pixel region PX2, and another portion 230b of the third color resist 230 is disposed in the third sub-pixel region PX3. Furthermore, the third color resist 230 is not overlapped with the first color resist 210 and the second color resist 220 in the third direction D3. Specifically, the first color resist 210 is not overlapped with the third color resist 230 in the third direction D3 within the first sub-pixel region PX1, and the second color resist 220 is not overlapped with the third color resist 230 in the third direction D3 within the second sub-pixel region PX2. According to the embodiment shown in FIG. 3 and FIG. 4, the portion 230a of the third color resist 230 may be disposed in the first sub-pixel region PX1 and the second sub-pixel region PX2 at the same time, but the present invention is not limited herein. In some embodiments, the portion 230a of the third color resist 230 may be disposed in the first sub-pixel region PX1 but not disposed in the second sub-pixel region PX2 (e.g. a color filter substrate CFb shown in FIG. 6), or the portion 230a of the third color resist 230 may be disposed in the second sub-pixel region PX2 but not disposed in the first sub-pixel region PX1 (e.g., a color filter substrate CFc shown in FIG. 8).

As shown in FIG. 3, FIG. 6 and FIG. 8, in the top view, the first color resist 210 may have an area A1, the second color resist 220 may have an area A2, the portion 230a of the third color resist 230 may have an area A3, and a sum of the area A3 of the portion 230a of the third color resist 230, the area A1 of the first color resist 210 and the area A2 of the second color resist 220 (i.e., the area of A1+A2+A3) is equal to a sum of the area of the first sub-pixel region PX1 and the area of the second sub-pixel region PX2. That is to say, the first color resist 210, the second color resist 220 and the portion 230a of the third color resist 230 may fill the first sub-pixel region PX1 and the second sub-pixel region PX2 without overlapping each other, and the another portion 230b of the third color resist 230 may fill the third sub-pixel region PX3.

In the first to fourth embodiments, the first color resist 210, the second color resist 220 and the third color resist 230 have different colors from each other. In some embodiments, when a thickness of the third color resist 230 is 1 micrometer (μm), the absorption rate of the third color resist 230 for light in the wavelength from 530 nanometers to 770 nanometers is greater than 0.2, the absorption rate of the third color resist 230 for light in the wavelength from 540 nanometers to 640 nanometers is greater than 0.35, and the absorption rate of the third color resist 230 for light in the wavelength from 400 nanometers to 500 nanometers is less than 0.1. Furthermore, when a thickness of the first color resist 210 is 1 micrometer, the absorption rate of the first color resist 210 for light in the wavelength below 460 nanometers and the wavelength from 630 nanometers to 690 nanometers is greater than 0.4, the absorption rate of the first color resist 210 for light in the wavelength from 640 nanometers to 680 nanometers is greater than 0.55, and the absorption rate of the first color resist 210 for light in the wavelength from 490 nanometers to 580 nanometers is less than 0.1. When a thickness of the second color resist 220 is 1 micrometer, the absorption rate of the second color resist 220 for light in the wavelength from 430 nanometers to 570 nanometers is greater than 0.5, the absorption rate of second color resist 220 for light in the wavelength from 540 nanometers to 565 nanometers is greater than 0.7, and the absorption rate of second color resist 220 for light in the wavelength above 600 nanometers is less than 0.1. However, the optical characteristics of the first color resist 210, the second color resist 220 and the third color resist 230 of the present invention are not limited to the above. In some embodiments, the optical characteristics of the first color resist 210 and the second color resist 220 may be interchanged with each other, i.e., in some embodiments, the first color resist 210 may have the optical characteristic of the second color resist 220 described above and the second color resist 220 may have the optical characteristic of the first color resist 210 described above. In this embodiment, one of the first color resist 210 and the second color resist 220 may be a green resist, the other one of the first color resist 210 and the second color resist 220 may be a red resist, and the third color resist 230 is a blue resist.

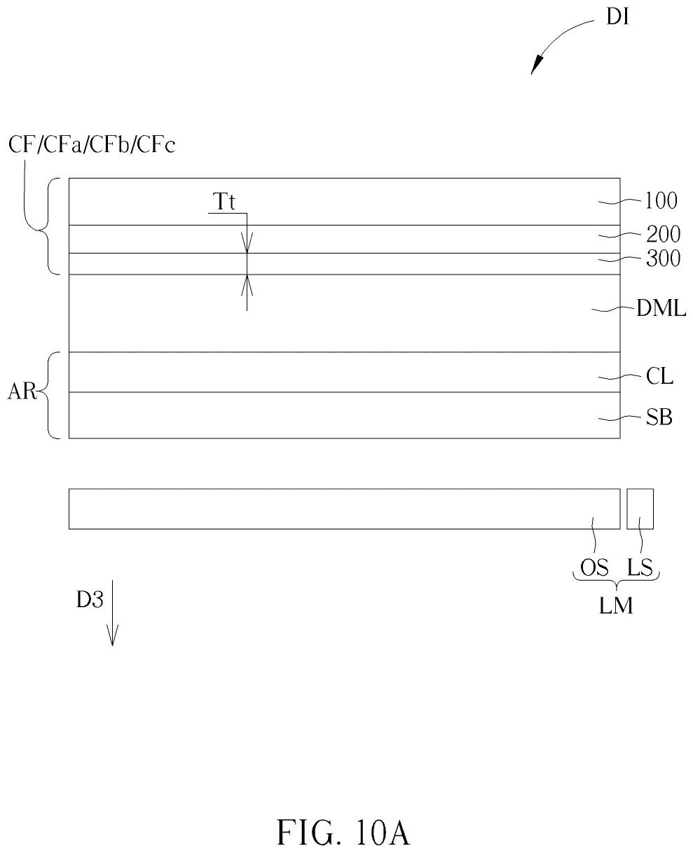

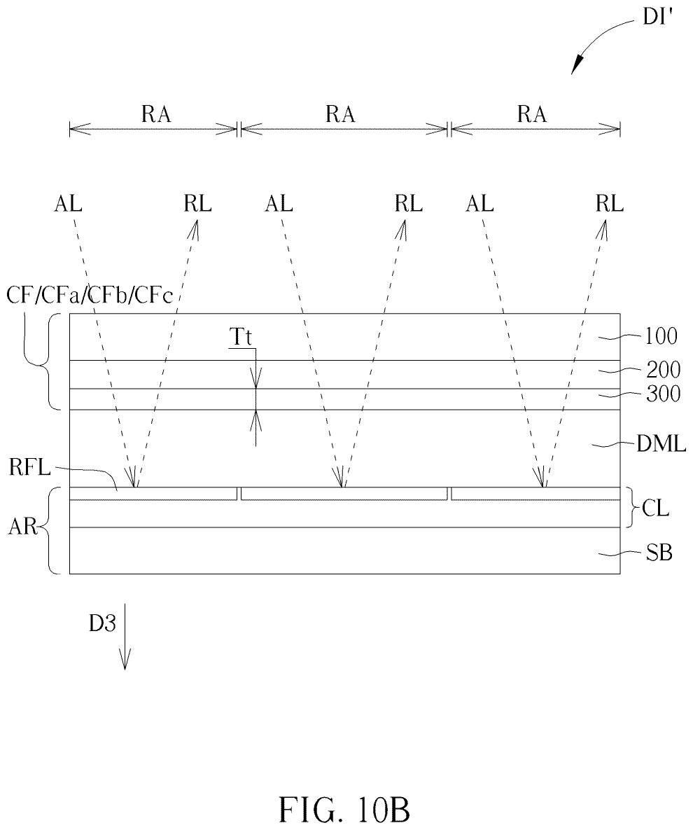

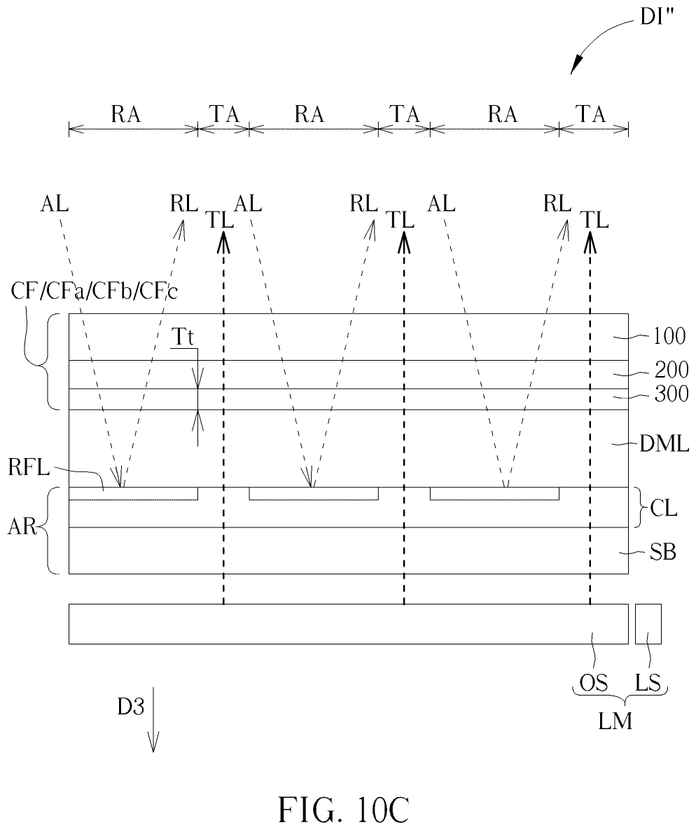

In the present invention, any one of the color filter substrate CF of FIG. 1, the color filter substrate CFa of FIG. 3, the color filter substrate CFb of FIG. 6 and the color filter substrate CFc of FIG. 8 may be applied to a display device DI shown in FIG. 10A, for example, wherein FIG. 10A is a schematic diagram illustrating a partial cross-sectional view of a display device according to an embodiment of the present invention. Refer to FIG. 10A, taken in conjunction with FIG. 1, FIG. 3, FIG. 6 and FIG. 8. As shown in FIG. 10A, the display device DI includes the color filter substrate CF (or one of the color filter substrate CFa, the color filter substrate CFb and the color filter substrate CFc) and an array substrate AR, and the array substrate AR and the color filter substrate CF are disposed opposite to each other. It should be noted that, the symbol CF/CFa/CFb/CFc in FIG. 10A and the following FIG. 10B and FIG. 10C indicates that the color filter substrate in the display device DI (or the display device DI′ in FIG. 10B and the display device DI″ in FIG. 10C in the following) may be one of the color filter substrate CF in FIG. 1, the color filter substrate CFa in FIG. 3, the color filter substrate CFb in FIG. 6 and the color filter substrate CFc in FIG. 8. The display device DI may be, for example, a display panel, and the display device DI may further include a display medium layer DML disposed between the color filter substrate CF and the array substrate AR, wherein the display medium layer DML includes, for example (but not limited to) liquid crystals. The regions of the display device DI corresponding to the first sub-pixel region PX1, the second sub-pixel region PX2 and the third sub-pixel region PX3 (shown in FIG. 1, FIG. 3, FIG. 6 and FIG. 8) may be used to display different colors respectively. For example, one of the first sub-pixel region PX1 and the second sub-pixel region PX2 may display green, the other of the first sub-pixel region PX1 and the second sub-pixel region PX2 may display red, and the third sub-pixel region PX3 may display blue.

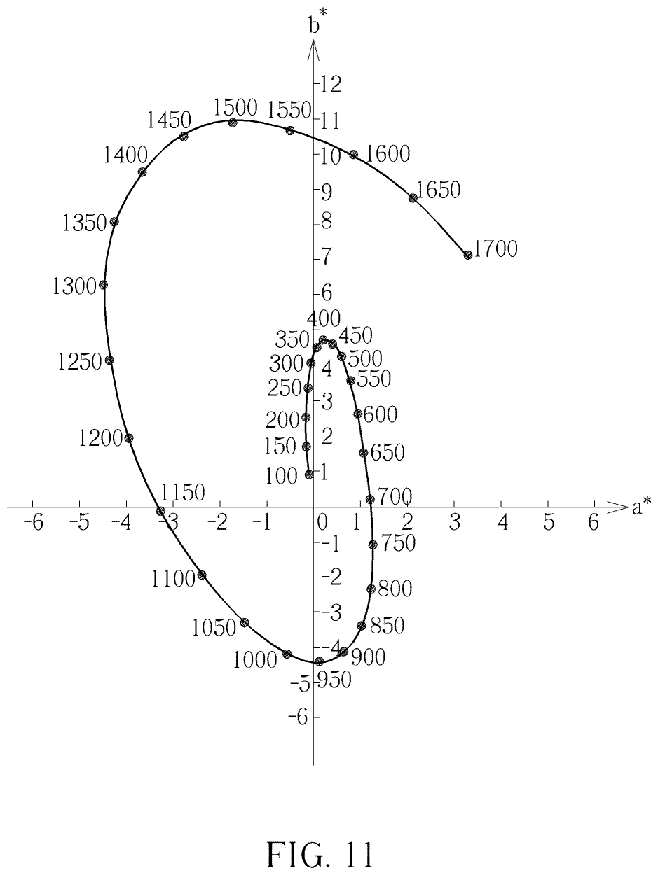

As shown in FIG. 10A, the color filter substrate CF may further include a transparent conductive layer 300 disposed on the surface of the substrate 100 facing the display medium layer DML, but not limited herein. In this embodiment, the transparent conductive layer 300 is disposed on the surface of the color resist structure 200. For example, the transparent conductive layer 300 may be disposed on a side of the color resist structure 200 opposite to the substrate 100 and cover the color resist structure 200, i.e., the color resist structure 200 may be disposed between the substrate 100 and the transparent conductive layer 300, but not limited herein. In some embodiments, the transparent conductive layer 300 may be disposed in the array substrate AR. The transparent conductive layer 300 may be used as a common electrode, for example, which may operate with a pixel electrode (not shown) in the array substrate AR to drive the display medium layer DML for displaying corresponding images. For example, in an embodiment that the display device DI is a liquid crystal display device, the display medium layer DML may be a liquid crystal layer, and the electric field between the transparent conductive layer 300 and the pixel electrode (not shown) may drive the liquid crystal molecules in the liquid crystal layer to display the corresponding images. The transparent conductive layer 300 may include a transparent conductive material such as indium tin oxide (ITO), but not limited herein. In the direction D3, a thickness Tt of the transparent conductive layer 300 may be greater than or equal to 1200 angstroms (Å) and less than or equal to 1700 angstroms, wherein the thickness Tt of the transparent conductive layer 300 within the above film thickness range may have better conductivity. As the film thickness of the transparent conductive layer 300 increases or decreases, the color thereof observed by naked eyes may change accordingly, as shown in FIG. 11. FIG. 11 is a graph diagram illustrating the relationship between different thicknesses of a transparent conductive layer and color coordinate values according to an embodiment of the present invention, wherein the horizontal axis corresponds to a* value and the vertical axis corresponds to b* value, and the curve shown in FIG. 11 depicts the respectively corresponding color coordinate values of the transparent conductive layer 300 with different thicknesses under a D65 light source. As shown in FIG. 11, when the thickness of the transparent conductive layer 300 is 1200 angstroms to 1700 angstroms, the b* value is about 2 to 11. According to the embodiment shown in FIG. 11, when the thickness of the transparent conductive layer 300 is 1200 angstroms to 1700 angstroms, the color of the corresponding color coordinate value is yellowish (i.e., the b* value is greater than 0), so the white point may shift to yellow when the transparent conductive layer 300 with the film thickness within the above range is disposed in the display device DI. However, through the structural design that a portion of the third color resist 230 in the color filter substrate CF, CFa, CFb or CFc in the present invention is disposed in at least one of the first sub-pixel region PX1 and the sub-pixel region PX2, the b* value may be adjusted (i.e., the b* value may be reduced) to mitigate or solve the problem of yellow shift of the white point, thereby improving the chromaticity representation of the display image of the display device DI. That is to say, in the condition that the thickness of the transparent conductive layer 300 is not changed for maintaining the good conductivity thereof, the design of the color resist structure 200 of the present invention may improve the display quality of the display device DI. In addition, the third color resist 230 of the color filter substrate CF in the first embodiment covers the first color resist 210 and the second color resist 220, while the third color resist 230 is not overlapped with the first color resist 210 and the second color resist 220 in the second to fourth embodiments, and thus compared with the first embodiment, the optical transmittance of the color resist structure 200 in the second to fourth embodiments may be improved, thereby reducing the influence on the luminance of the white dot.

In some embodiments, the color filter substrate CF may further include a black matrix (BM) and/or a planarization layer (not shown) disposed between the color resist structure 200 and the transparent conductive layer 300, but not limited herein. In some embodiments, as shown in FIG. 10A, the array substrate AR may include a substrate SB and a circuit layer CL disposed on the substrate SB, i.e., the circuit layer CL may be disposed between the substrate SB and the display medium layer DML. The substrate SB may include a rigid substrate or a flexible substrate, and the material of the substrate SB may refer to the material of the substrate 100 described above, which will not be described redundantly herein. The circuit layer CL may include elements such as gate lines, data lines, thin film transistors and/or pixel electrodes, but not limited herein. For example, the gate lines and the data lines in the circuit layer CL may intersect with each other to define a plurality of sub-regions, and three of the sub-regions respectively correspond to the first sub-pixel region PX1, the second sub-pixel region PX2 and the third sub-pixel region PX3 of the color filter substrate CF (or one of the color filter substrates CFa, CFb and CFc), and each sub-region may include one or more thin film transistors for controlling the image display of each sub-region.

Furthermore, the display device DI may optionally include a light source module LM, disposed on a side of the color filter substrate CF or the array substrate AR. In the embodiment shown in FIG. 10A, the light source module LM is, for example, a backlight module, which is disposed on a side of the array substrate AR opposite to the color filter substrate CF and may include an optical structure OS and a light source LS. The optical structure OS may include a light guide plate, a diffuser and/or a prism sheet or other suitable optical films. In the above embodiment, the light source module LM is an edge-lit backlight module for example, but not limited herein. In another embodiment, the light source module LM may be a direct-lit backlight module, i.e., the light source is disposed below the array substrate AR in the third direction D3. In this embodiment, the display device DI including the light source module LM may be a transmissive type display device, i.e., the light of the light source module LM may pass through the array substrate AR, the display medium layer DML and the color filter substrate CF to display the corresponding image.

In some embodiments, the display device DI may be a self-luminous display device, such as (but not limited to) an organic light-emitting diode display device or a micro light-emitting diode display device, wherein the display device DI may not include the light source module LM, and the display medium layer DML may include, for example (but not limited to), light-emitting diodes. The transparent conductive layer 300 may not be a part of the color filter substrate CF, and the transparent conductive layer 300 operates with pixel electrodes (not shown) in the array substrate AR for driving the display medium layer DML to emit light (e.g., driving the organic light-emitting diodes to emit light), so as to display the corresponding image.

Any one of the color filter substrates CF, CFa, CFb and CFc of the present invention may also be applied to the display device DI′ shown in FIG. 10B or the display device DI″ shown in FIG. 10C, for example. Refer to FIG. 10B and FIG. 10C. FIG. 10B is a schematic diagram illustrating a partial cross-sectional view of a display device according to another embodiment of the present invention. FIG. 10C is a schematic diagram illustrating a partial cross-sectional view of a display device according to still another embodiment of the present invention. As shown in FIG. 10B, the display device DI′ shown in FIG. 10B is a reflective type display device, wherein the plurality of sub-regions of the circuit layer CL have reflective regions RA respectively, and reflective plates RFL are disposed in the reflective regions RA and used for reflecting the ambient light or light from a front light module to form reflected light RL for displaying images. It is noted that the ambient light and/or light from the front light module is labeled as “AL” in FIG. 10B and FIG. 10C. In some embodiments, the display device DI′ may further include a front light source module (not shown) disposed on a side of the color filter substrate CF facing away from to the array substrate AR. As shown in FIG. 10C, the display device DI″ shown in FIG. 10C is a transflective type display device, wherein each sub-region of the circuit layer CL has a reflective region RA and a transmissive region TA. The reflective plates RFL are disposed in the reflective regions RA and used for reflecting the ambient light AL or light AL from a front light module to form reflected light RL for displaying images, while no reflective plate RFL exists in the transmissive regions TA, and the light from the light source module LM may pass through the transmissive regions TA to form transmissive light TL for displaying images when the light source module LM is turned on. In addition, in variant embodiments of FIG. 10B and FIG. 10C, the transparent conductive layer 300 may be disposed in the array substrate AR.

In the embodiment shown in FIG. 10A, the light from the light source module LM may pass through the array substrate AR, the display medium layer DML and the color filter substrate CF (or one of the color filter substrates CFa, CFb and CFc) for displaying the corresponding image, i.e., each light for displaying the image only passes through the transparent conductive layer 300 of the color filter substrate CF once. In the embodiments of shown in FIG. 10B and FIG. 10C, the ambient light AL or the light AL from the front light module passes through the transparent conductive layer 300 of the color filter substrate CF, and the reflected light RL also passes through the transparent conductive layer 300 of the color filter substrate CF, i.e., each light for displaying the image passes through the transparent conductive layer 300 of the color filter substrate CF twice.

According to the first embodiment shown in FIG. 1 and FIG. 2, the first color resist 210 is disposed in a whole area of the first sub-pixel region PX1, the second color resist 220 is disposed in a whole area of the second sub-pixel region PX2, the portion 230a of the third color resist 230 is disposed in the whole area of the first sub-pixel region PX1 and the whole area of the second sub-pixel region PX2, and the another portion 230b of the third color resist 230 is disposed in a whole area of the third sub-pixel region PX3. That is to say, in the top view, the portion 230a of the third color resist 230 may fill the first sub-pixel region PX1 and the second sub-pixel region PX2, and the another portion 230b of the third color resist 230 may fill the third sub-pixel region PX3. In the third direction D3, the portion 230a of the third color resist 230 disposed in the first sub-pixel region PX1 and the second sub-pixel region PX2 has a first thickness T1, the another portion 230b of the third color resist 230 disposed in the third sub-pixel region PX3 has a second thickness T2, and the first thickness T1 is less than the second thickness T2. Based on the design spirit of the present invention, according to the degree of yellow shift of the white point caused by the thickness Tt of the transparent conductive layer 300 (as shown in FIG. 10A, FIG. 10B, FIG. 10C and FIG. 11), the film thickness of the portion 230a of the third color resist 230 covering the first color resist 210 and the second color resist 220 (i.e., the first thickness T1) may be adjusted to mitigate or solve the problem of yellow shift of the white point.

As shown in FIG. 2, in the third direction D3, the first color resist 210 has a thickness T3, and the second color resist 220 has a thickness T4. In some embodiments, at least one of the thickness T3 of the first color resist 210 and the thickness T4 of the second color resist 220 may be greater than or equal to 0.5 micrometers and less than or equal to 3 micrometers (i.e., 0.5 μm≤T3≤3 μm and/or 0.5 μm≤T4≤3 μm). The first thickness T1 of the portion 230a of the third color resist 230 may be greater than or equal to 0.2 micrometers and less than or equal to 0.5 micrometers (i.e., 0.2 μm≤T1≤0.5 μm), i.e., the portion 230a of the third color resist 230 may be 0.2 to 0.5 micrometers higher than the first color resist 210 and the second color resist 220 with respect to the substrate 100, so that the portion 230a of the third color resist 230 can completely cover the first color resist 210 in the first sub-pixel region PX1 and the second color resist 220 in the second sub-pixel region PX2 and the b* value may be reduced. The second thickness T2 of the another portion 230b of the third color resist 230 may be greater than or equal to 0.5 micrometers and less than or equal to 3 micrometers (i.e., 0.5 μm≤T2≤3 μm). In some embodiments, the second thickness T2 may be equal to the sum of the thickness T3 of the first color resist 210 and the first thickness T1 (i.e., T2=T3+T1), and the second thickness T2 may be further equal to the sum of the thickness T4 of the second color resist 220 and the first thickness T1 (i.e., T2=T4+T1), so that the surfaces of the color resist structure 200 are aligned to each other in the first sub-pixel region PX1, the second sub-pixel region PX2 and the third sub-pixel region PX3, i.e., the surface of the portion 230a of the third color resist 230 in the first sub-pixel region PX1 and the second sub-pixel region PX2 is aligned with the surface of the portion 230b of the third color resist 230 in the third sub-pixel region PX3, but not limited herein. According to the structure and film thickness design of the first color resist 210, the second color resist 220 and the third color resist 230, the b* value may be reduced, such as being reduced by 3 to 9, thereby effectively mitigating the problem of yellow shift of the white point.

Refer to the second embodiment shown in FIG. 3, the third embodiment shown in FIG. 6 and the fourth embodiment shown in FIG. 8. In the top-view, a ratio of the area A1 of the first color resist 210 to the area of the first sub-pixel region PX1 may be greater than or equal to 0.2 and less than or equal to 1, i.e., the area A1 of the first color resist 210 may account for 20% to 100% of the total area of the first sub-pixel region PX1, but not limited herein. When the ratio of the area A1 of the first color resist 210 to the area of the first sub-pixel region PX1 is less than 1 (as shown in FIG. 3 and FIG. 6), the first color resist 210 is not disposed in the whole area of the first sub-pixel region PX1 (i.e., a portion of the first sub-pixel region PX1 is not provided with the first color resist 210). Specifically, the first sub-pixel region PX1 may include a first portion PX1a and a second portion PX1b, and the first portion PX1a is not overlapped with the second portion PX1b in the third direction D3, wherein the first color resist 210 is disposed in the first portion PX1a but not disposed in the second portion PX1b. Furthermore, at this time, the portion 230a of the third color resist 230 may be at least partially disposed in the second portion PX1b. For example, a part of the portion 230a of the third color resist 230 is disposed in the second portion PX1b and another part thereof is disposed in the second sub-pixel region PX2 (as shown in FIG. 3), or the portion 230a of the third color resist 230 may be completely disposed in the second portion PX1b and not disposed in the second sub-pixel region PX2 (as shown in FIG. 6). The second portion PX1b may be, for example, located at a side of the first portion PX1a in the second direction D2 and connected to the second sub-pixel region PX2 in the first direction D1, but not limited herein. When the ratio of the area A1 of the first color resist 210 to the area of the first sub-pixel region PX1 is equal to 1 (as shown in FIG. 8), the first color resist 210 is disposed in the whole area of the first sub-pixel region PX1 (i.e., the shape of the first color resist 210 in the first sub-pixel region PX1 substantially completely corresponds to the shape of the first sub-pixel region PX1), wherein the first color resist 210 completely fills the first sub-pixel region PX1, and the portion 230a of the third color resist 230 is completely disposed in the second sub-pixel region PX2 and not disposed in the first sub-pixel region PX1.

According to the second embodiment shown in FIG. 3, the third embodiment shown in FIG. 6 and the fourth embodiment shown in FIG. 8, a ratio of the area A2 of the second color resist 220 to the area of the second sub-pixel region PX2 may be greater than or equal to 0.2 and less than or equal to 1, i.e., the area A2 of the second color resist 220 may account for 20% to 100% of the total area of the second sub-pixel region PX2, but not limited herein. When the ratio of the area A2 of the second color resist 220 to the area of the second sub-pixel region PX2 is less than 1 (as shown in FIG. 3 and FIG. 8), the second color resist 220 is not disposed in the whole area of the second sub-pixel region PX2 (i.e., a portion of the second sub-pixel region PX2 is not provided with the second color resist 220). Specifically, the second sub-pixel region PX2 may include a third portion PX2a and a fourth portion PX2b, and the third portion PX2a is not overlapped with the fourth portion PX2b in the third direction D3, wherein the second color resist 220 may be disposed in the third portion PX2a but not disposed in the fourth portion PX2b. Furthermore, at this time, the portion 230a of the third color resist 230 may be at least partially disposed in the fourth portion PX2b. For example, a part of the portion 230a of the third color resist 230 is disposed in the second portion PX1b and another part thereof is disposed in the fourth portion PX2b (as shown in FIG. 3), or the portion 230a of the third color resist 230 may be completely disposed in the fourth portion PX2b and not disposed in the first sub-pixel region PX1 (as shown in FIG. 8). The fourth portion PX2b may be, for example, located at a side of the third portion PX2a in the second direction D2 and connected to the first sub-pixel region PX1 in the first direction D1, but not limited herein. When the ratio of the area A2 of the second color resist 220 to the area of the second sub-pixel region PX2 is equal to 1 (as shown in FIG. 6), the second color resist 220 is disposed in the whole area of the second sub-pixel region PX2 (i.e., the shape of the second color resist 220 in the second sub-pixel region PX2 substantially completely corresponds to the shape of the second sub-pixel region PX2), wherein the second color resist 220 completely fills the second sub-pixel region PX2, and the portion 230a of the third color resist 230 is completely disposed in the second portion PX1b of the first sub-pixel region PX1 and not disposed in the second sub-pixel region PX2.

In the embodiment that the ratio of the area A1 of the first color resist 210 to the area of the first sub-pixel region PX1 is greater than or equal to 0.2 and less than 1 and the ratio of the area A2 of the second color resist 220 to the area of the second sub-pixel region PX2 is greater than or equal to 0.2 and less than 1, the area A1 of the first color resist 210 may be the same as or different from the area A2 of the second color resist 220. For example, in the embodiment shown in FIG. 3, the first color resist 210 may be green, the second color resist 220 may be red, and the third color resist 230 may be blue. The area A1 of the first color resist 210 may be less than the area A2 of the second color resist 220, the area A2 of the second color resist 220 may be less than the area of the another portion 230b of the third color resist 230, and the portion 230a of the third color resist 230 is disposed in the region in the first sub-pixel region PX1 where the first color resist 210 is not disposed and the region in the second sub-pixel region PX2 where the second color resist 220 is not disposed, thereby preventing the image from being yellowish and also realizing high color saturation, but not limited herein. It should be noted that, the area A1 of the first color resist 210, the area A2 of the second color resist 220, the area of the another portion 230b of the third color resist 230, and the areas of the first sub-pixel region PX1 and the second sub-pixel region PX2 described above are respectively the areas thereof on the plane formed by the first direction D1 and the second direction D2 (i.e., the vertical projected areas of the first color resist 210, the second color resist 220, the another portion 230b of the third color resist 230, and the first sub-pixel region PX1 and the second sub-pixel region PX2 on the substrate 100).

Refer to FIG. 4 and FIG. 5, in conjunction with FIG. 3, FIG. 10A and FIG. 11. As shown in FIG. 4 and FIG. 5, in the third direction D3, the portion 230a of the third color resist 230 disposed in the first sub-pixel region PX1 and/or the second sub-pixel region PX2 has a first thickness T5, the another portion 230b of the third color resist 230 disposed in the third sub-pixel region PX3 has a second thickness T6, the first color resist 210 has a thickness T7, and the second color resist 220 has a thickness T8. According to the degree of yellow shift of the white point caused by the thickness Tt of the transparent conductive layer 300 (as shown in FIG. 10A, FIG. 10B, FIG. 10C and FIG. 11), the size of the first thickness T5 of a the portion 230a of the third color resist 230 in the third direction D3 may be correspondingly adjusted to mitigate or solve the problem of yellow shift of the white point.

In some embodiments, the thickness T7 of the first color resist 210 and/or the thickness T8 of the second color resist 220 may be greater than or equal to 0.5 micrometers and less than or equal to 3 micrometers (i.e., 0.5 μm≤T7≤3 μm and/or 0.5 μm≤T8≤3 μm), and a difference between the first thickness T5 of the portion 230a of the third color resist 230 and the thickness T7 of the first color resist 210 and/or a difference between the first thickness T5 and the thickness T8 of the second color resist 220 may range from −1 micrometer to 1 micrometer (i.e., 1 μm≤(T5−T7)≤1 μm and/or −1 μm≤(T5−T8)≤1 μm), so that the b* value may be maintained at approximately 0, so as to mitigate or solve the problem of yellow shift of the white point caused by the transparent conductive layer, and the luminance of the white point may be increased by about 10% at the same time. In other embodiments, the first thickness T5 of the portion 230a of the third color resist 230 may be different from the thickness T7 of the first color resist 210 and the thickness T8 of the second color resist 220. For example, the first thickness T5 may be designed to be greater than or less than the thickness T7 and the thickness T8 according to the degree of yellow shift of the white point. In some embodiments, the second thickness T6 of the another portion 230b of the third color resist 230 may be greater than or equal to 0.5 micrometers and less than or equal to 3 micrometers. For example, the second thickness T6 of the another portion 230b of the third color resist 230 may be equal to the thickness T7 of the first color resist 210 and/or the thickness T8 of the second color resist 220, so that the surfaces of the first color resist 210, the second color resist 220 are the portion 230b of the third color resist 230 are aligned with each other, but not limited herein.

Refer to FIG. 7 and FIG. 9, in conjunction with FIG. 6 and FIG. 8. In the embodiments shown in FIG. 6 and FIG. 8, the ranges of a thickness T9 (shown in FIG. 7) and a thickness T10 (shown in FIG. 9) of the portion 230a of the third color resist 230 may be similar to the range of the first thickness T5 of the portion 230a of the third color resist 230 shown in FIG. 4, but not limited herein.

In the current transmissive type display devices or self-luminous display devices, each light used for displaying the image may pass through the transparent conductive layer of the color filter substrate once, thus causing the image to be yellowish (as shown in FIG. 11). In the current reflective type display devices and transflective type display devices, the ambient light or the light from the front light module may pass through the transparent conductive layer of the color filter substrate, and the reflected light also may pass through the transparent conductive layer of the color filter substrate, i.e., each light used for displaying the image passes through the transparent conductive layer of the color filter substrate twice, thus causing the phenomenon of the yellowish image to be more severe than that of the transmissive type display devices or self-luminous display devices. Therefore, any one of the color filter substrates CF, CFa, CFb and CFc of the present invention may be applied not only to the transmissive type display device or the self-luminous display device, but may be also applied to the reflective type display device and the transflective type display device to solve the more severe problem of the yellowish image.

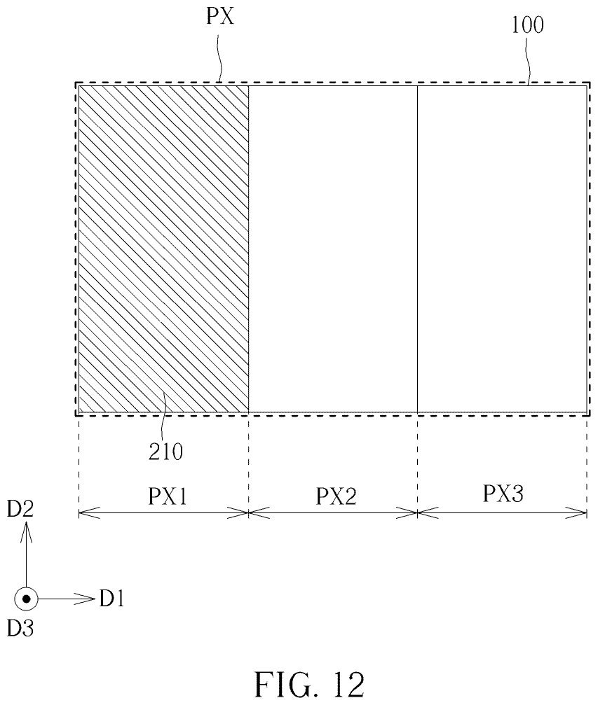

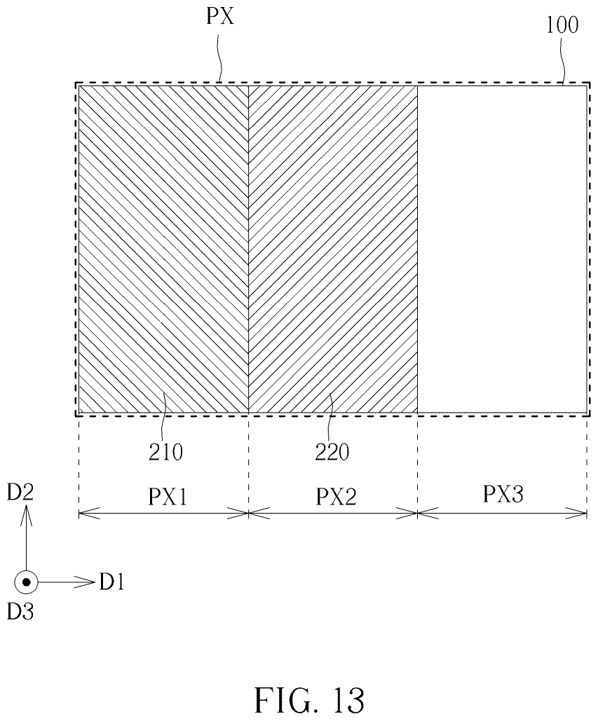

Refer to FIG. 12, FIG. 13 and FIG. 1. FIG. 12 and FIG. 13 are schematic diagrams illustrating partial processes of a manufacturing method of a color filter substrate according to a first embodiment of the present invention. A manufacturing method of the color filter substrate CF of a first embodiment of the present invention may include the process steps shown in FIG. 12, FIG. 13 and FIG. 1. As shown in FIG. 12, the first color resist 210 is coated in the first sub-pixel region PX1 of the substrate 100, and an exposure process and a development process are performed to 100% of the area of the first sub-pixel region PX1, so that the first color resist 210 is disposed on the substrate 100 in a manner of filling the first sub-pixel region PX1. The film thickness of the first color resist 210 that is coated may be, for example, greater than or equal to 0.5 micrometers and less than or equal to 3 micrometers, but no limited herein. After the first color resist 210 is exposed and developed, as shown in FIG. 13, the second color resist 220 is coated in the second sub-pixel region PX2 of the substrate 100, and an exposure process and a development process are performed to 100% of the area of the second sub-pixel region PX2, so that the second color resist 220 is disposed on the substrate 100 in a manner of filling the second sub-pixel region PX2. The film thickness of the second color resist 220 that is coated may be, for example, greater than or equal to 0.5 micrometers and less than or equal to 3 micrometers, but not limited herein. In some embodiments, the forming order of the first color resist 210 and the second color resist 220 may be interchanged.

After the second color resist 220 is exposed and developed, as shown in FIG. 1, the third color resist 230 is coated in the first sub-pixel region PX1, the second sub-pixel region PX2 and the third sub-pixel region PX3 of the substrate 100, and an exposure process and a development process are performed to 100% of the area of the first sub-pixel region PX1, the second sub-pixel region PX2 and the third sub-pixel region PX3 (i.e., the area of the pixel region PX), so that the third color resist 230 is disposed on the substrate 100 in a manner of being blanketly coating on or filling each sub-pixel region, and thus the manufacturing of the color resist structure 200 is completed.

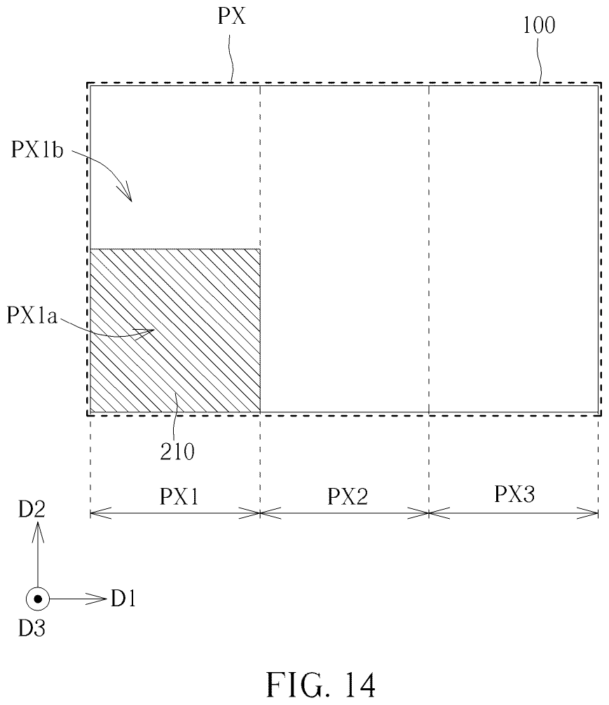

Refer to FIG. 14 to FIG. 16 and FIG. 3. FIG. 14 to FIG. 16 are schematic diagrams illustrating partial processes of a manufacturing method of a color filter substrate according to a second embodiment of the present invention. A manufacturing method of the color filter substrate CFa of a second embodiment of the present invention may include the process steps shown in FIG. 14 to FIG. 16 and FIG. 3. As shown in FIG. 14, firstly, the first color resist 210 is coated in the first sub-pixel region PX1 of the substrate 100, and an exposure process and a development process are performed to 20% to 100% of the area of the first sub-pixel region PX1, so that the first color resist 210 is disposed on the substrate 100 in a manner of partially filling or completely filling the first sub-pixel region PX1, i.e., 0% to 80% of the area of the first sub-pixel region PX1 is not provided with the first color resist 210. The film thickness of the first color resist 210 may be, for example, greater than or equal to 0.5 micrometers and less than or equal to 3 micrometers, but no limited herein. According to the embodiment shown in FIG. 14, after the exposure and development processes, the first color resist 210 may be disposed in the first portion PX1a of the first sub-pixel region PX1 but not in the second portion PX1b of the first sub-pixel region PX1.

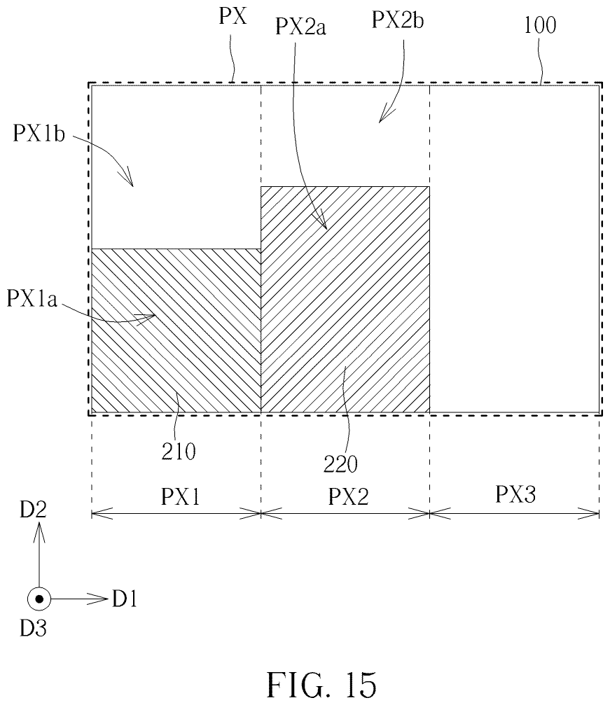

After the first color resist 210 is exposed and developed, as shown in FIG. 15, the second color resist 220 is coated in the second sub-pixel region PX2 of the substrate 100, and an exposure process and a development process are performed to 20% to 100% of the area of the second sub-pixel region PX2, so that the second color resist 220 is disposed on the substrate 100 in a manner of partially filling or completely filling the second sub-pixel region PX2, i.e., 0% to 80% of the area of the second sub-pixel region PX2 is not provided with the second color resist 220. The film thickness of the second color resist 220 may be, for example, greater than or equal to 0.5 micrometers and less than or equal to 3 micrometers, but not limited herein. According to the embodiment shown in FIG. 15, after the exposure and development processes, the second color resist 220 may be disposed in the third portion PX2a of the second sub-pixel region PX2 but not in the fourth portion PX2b of the second sub-pixel region PX2.

It should be noted that, the exposed and developed areas of the first color resist 210 and the second color resist 220 of the present invention are not limited to the embodiment shown in FIG. 14 and FIG. 15. In some embodiments (such as the fourth embodiment of FIG. 8), an exposure process and a development process are performed to 100% of the area of the first sub-pixel region PX1 coated with the first color resist 210, so that the first color resist 210 is disposed on the substrate 100 in a manner of completely filling the first sub-pixel region PX1, and then an exposure process and a development process are performed to an area greater than or equal to 20% and less than 100% of the area of the second sub-pixel region PX2 coated with the second color resist 220, so that the second color resist 220 is disposed on the substrate 100 in a manner of partially filling the second sub-pixel region PX2. In other embodiments (such as the third embodiment of FIG. 6), an exposure process and a development process are performed to an area greater than or equal to 20% and less than 100% of the area of the first sub-pixel region PX1 coated with the first color resist 210, so that the first color resist 210 is disposed on the substrate 100 in a manner of partially filling the first sub-pixel region PX1, and then an exposure process and a development process are performed to 100% of the area of the second sub-pixel region PX2 coated with the second color resist 220, so that the second color resist 220 is disposed on the substrate 100 in a manner of completely filling the second sub-pixel region PX2. In still other embodiments, in the first sub-pixel region PX1 and the second sub-pixel region PX2, the coating of the first color resist 210 and the second color resist 220 may be interchanged with each other, i.e., one of the first color resist 210 and the second color resist 220 may be coated in the first sub-pixel region PX1 and the other of the first color resist 210 and the second color resist 220 may be coated in the second sub-pixel region PX2.

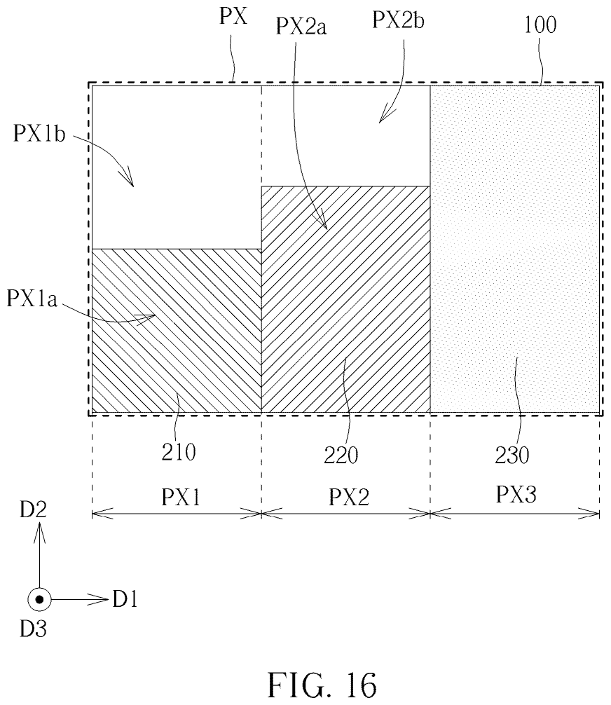

After the second color resist 220 is exposed and developed, as shown in FIG. 16, the third color resist 230 is coated in the third sub-pixel region PX3 of the substrate 100, and an exposure process and a development process are performed to 100% of the area of the third sub-pixel region PX3, so that the third color resist 230 is disposed on the substrate 100 in a manner of filling the third sub-pixel region PX3 (i.e., the portion 230b of the third color resist 230 shown in FIG. 3). The film thickness of the third color resist 230 in the third sub-pixel region PX3 may be, for example, greater than or equal to 0.5 micrometers and less than or equal to 3 micrometers, but not limited herein.

After the third color resist 230 in the third sub-pixel region PX3 is formed, as shown in FIG. 3, the third color resist 230 is coated in the second portion PX1b of the first sub-pixel region PX1 and the fourth portion PX2b of the second sub-pixel region PX2, and an exposure process and a development process are performed to 100% of the area of the second portion PX1b and the fourth portion PX2b, so that the third color resist 230 is disposed on the substrate 100 in a manner of filling the second portion PX1b and the fourth portion PX2b (i.e., the portion 230a of the third color resist 230 shown in FIG. 3), and thus the manufacturing of the color resist structure 200 is completed. In some embodiments, the order of the step in FIG. 16 described above may be exchanged with the order of this step, i.e., the portion 230a of the third color resist 230 fills the second portion PX1b and the fourth portion PX2b first, and then the portion 230b of the third color resist 230 fills the third sub-pixel region PX3. In some embodiments, when the first color resist 210 is disposed in the whole area of the first sub-pixel region PX1 (such as the fourth embodiment of FIG. 8), this step may be coating the third color resist 230 in the fourth portion PX2b of the second sub-pixel region PX2 and perform an exposure process and a development process only to 100% of the area of the fourth portion PX2b. In other embodiments, when the second color resist 220 is disposed in the whole area of the second sub-pixel region PX2 (such as the third embodiment of FIG. 6), this step may be coating the third color resist 230 in the second portion PX1b of the first sub-pixel region PX1 and performing an exposure process and a development process only to 100% of the area of the second portion PX1b. The film thickness of the third color resist 230 disposed in the second portion PX1b and/or the fourth portion PX2b may be adjusted according to the different degrees of yellow shift of the white point caused by the thickness Tt of the transparent conductive layer 300 (as shown in FIG. 10A, FIG. 10B, FIG. 10C and FIG. 11), so as to maintain the b* value at approximately 0.

It should be noted that in the manufacturing methods of the color filter substrates in the first to fourth embodiments described above, the materials of the first color resist 210, the second color resist 220 and the third color resist 230 may include negative photoresist materials (i.e., the illuminated part of the color resist material is insoluble in the developer) as an example, but not limited herein. In some embodiments, the materials of the first color resist 210, the second color resist 220, and the third color resist 230 may be positive photoresist materials, which will not be described redundantly herein. In addition, the method of forming the first color resist 210, the second color resist 220 and the third color resist 230 of the present invention is not limited to the above embodiments. In the subsequent steps, a transparent conductive layer or other elements on the color filter substrate may be optionally formed on the color resist structure 200. In addition, the third color resist 230 of the color filter substrate CF in the first embodiment covers the first color resist 210 and the second color resist 220, while the third color resist 230 is not overlapped with the first color resist 210 and the second color resist 220 in the second to fourth embodiments, and thus compared with the first embodiment, the optical transmittance of the color resist structure 200 in the second to fourth embodiments may be improved, thereby reducing the influence on the luminance of the white dot.

From the above description, according to an embodiment of the present invention, sub-pixel regions corresponding to green, red and blue may be defined on the color filter substrate CF, CFa, CFb or CFc, wherein a green resist and a red resist are respectively disposed in the green sub-pixel region and the red sub-pixel region, and the blue resist is not only disposed in the blue sub-pixel region but also disposed in at least one of the red sub-pixel region and the green sub-pixel region to mitigate or solve the problem of yellow shift of the white point. It should be noted that the present invention is not limited to the above exemplified colors of the sub-pixels and the color resists. In different embodiments, the design of disposing a color resist with one color in sub-pixel regions with other colors to adjust light-outputting performance may be changed and adjusted according to practical requirements, and colors of the first sub-pixel region, the second sub-pixel region and the third sub-pixel region or colors of the first color resist, the second color resist and the third color resist are not limited to the above.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A color filter substrate, comprising:
a substrate having a pixel region, wherein the pixel region comprises a first sub-pixel region, a second sub-pixel region and a third sub-pixel region; and
a color resist structure disposed on the substrate, the color resist structure comprising:
a first color resist disposed in the first sub-pixel region;
a second color resist disposed in the second sub-pixel region; and
a third color resist, wherein a portion of the third color resist is disposed in at least one of the first sub-pixel region and the second sub-pixel region, and another portion of the third color resist is disposed in the third sub-pixel region,
wherein the first color resist, the second color resist and the third color resist have different colors from each other.

2. The color filter substrate according to claim 1, wherein one of the first color resist and the second color resist is a green resist, the other one of the first color resist and the second color resist is a red resist, and the third color resist is a blue resist.

3. The color filter substrate according to claim 1, wherein the portion of the third color resist is disposed in the first sub-pixel region and the second sub-pixel region, and the portion of the third color resist covers the first color resist and the second color resist in a normal direction of the substrate.

4. The color filter substrate according to claim 3, wherein in the normal direction, the portion of the third color resist disposed in the first sub-pixel region and the second sub-pixel region has a first thickness, the another portion of the third color resist disposed in the third sub-pixel region has a second thickness, and the first thickness is less than the second thickness.

5. The color filter substrate according to claim 4, wherein the first thickness is greater than or equal to 0.2 micrometers and less than or equal to 0.5 micrometers.

6. The color filter substrate according to claim 4, wherein the second thickness is greater than or equal to 0.5 micrometers and less than or equal to 3 micrometers.

7. The color filter substrate according to claim 3, wherein in the normal direction, a thickness of at least one of the first color resist and the second color resist is greater than or equal to 0.5 micrometers and less than or equal to 3 micrometers.

8. The color filter substrate according to claim 3, wherein the first color resist is disposed in a whole area of the first sub-pixel region, the second color resist is disposed in a whole area of the second sub-pixel region, and the portion of the third color resist is disposed in the whole area of the first sub-pixel region and the whole area of the second sub-pixel region.

9. The color filter substrate according to claim 1, wherein the portion of the third color resist is not overlapped with the first color resist and the second color resist in a normal direction of the substrate.

10. The color filter substrate according to claim 9, wherein
the first sub-pixel region comprises a first portion and a second portion, and the first portion is not overlapped with the second portion, wherein the first color resist is disposed in the first portion but not disposed in the second portion; and
the portion of the third color resist is at least partially disposed in the second portion.

11. The color filter substrate according to claim 10, wherein
the second sub-pixel region comprises a third portion and a fourth portion, and the third portion is not overlapped with the fourth portion, wherein the second color resist is disposed in the third portion but not disposed in the fourth portion; and
the portion of the third color resist is further disposed in the fourth portion.

12. The color filter substrate according to claim 9, wherein a ratio of an area of the first color resist to an area of the first sub-pixel region is greater than or equal to 0.2.

13. The color filter substrate according to claim 12, wherein a ratio of an area of the second color resist to an area of the second sub-pixel region is greater than or equal to 0.2.

14. The color filter substrate according to claim 9, wherein a sum of area of the portion of the third color resist, the first color resist and the second color resist is equal to a sum of area of the first sub-pixel region and the second sub-pixel region.

15. The color filter substrate according to claim 9, wherein in the normal direction, the portion of the third color resist disposed in the first sub-pixel region or the second sub-pixel region has a first thickness, and a difference between the first thickness and a thickness of the first color resist or a difference between the first thickness and a thickness of the second color resist ranges from −1 micrometer to 1 micrometer.

16. The color filter substrate according to claim 1, further comprising a transparent conductive layer disposed on the color resist structure.

17. The color filter substrate according to claim 16, wherein in the normal direction, a thickness of the transparent conductive layer is greater than or equal to 1200 angstroms and less than or equal to 1700 angstroms.

18. A display device, comprising:
the color filter substrate of claim 1; and
an array substrate, wherein the array substrate and the color filter substrate are disposed opposite to each other.
